(19) United States
(12) Patent Application Publication
(10) Pub. No.: US 2012/0026412 A1
(43) Pub. Date: Feb. 2, 2012

(54) REMOTE CONTROLLABLE DEVICE WITH OFFSET REMOTE RECEIVER

(75) Inventor: HSU-CHIA KAO, Tu-Cheng (TW)

(73) Assignee: HON HAI PRECISION INDUSTRY CO., LTD., Tu-Cheng (TW)

(21) Appl. No.: 13/193,629

(22) Filed: Jul. 29, 2011

(30) Foreign Application Priority Data
Jul. 29, 2010 (CN) 201010240214.8

(51) Int. Cl. H04N 5/44

(52) U.S. Cl. 348/734; 348/E05.096

(57) ABSTRACT

An exemplary remote controllable device includes a remote receiver for receiving an external remote control signal. The remote receiver is located at one side of a main operation surface relative to a center reference plane of the main operation surface. A direction pointing from the center reference plane to the remote receiver determines a reference direction. The remote receiver includes a remote receiving head and a protection window with another center reference plane. The remote receiving head is offset from the center reference plane of the protection window in a direction the same as the reference direction.

### BACKGROUND

1. Technical Field

The disclosure generally relates to electronic devices that have a function of receiving external remote signals using a remote receiver.

2. Description of Related Art

Currently, a wide variety of devices, such as televisions (TVs), Digital Video Disc (DVD) players, stereo systems and air conditioners, come with remote controls. The remote controls allow various functions of the devices to be controlled.

In a TV for example, a remote receiver is installed in a housing of the TV to receive remote control signals emitted from a remote control. For this purpose, the remote control establishes a direct communication connection with the device to be controlled. Typically, the communication connection is an infrared signal connection. The remote control sends infrared ray signals corresponding to control commands Typically, the remote receiver is arranged at one side of a center axis of a body of the device to receive the remote control signals.

Although the communication between the remote receiver and the remote control works by line of sight, signals coming from an acute angle to the surface of the device where the receiver is located may not be reliably received. For example, if the remote receiver is located in the bottom right corner of a TV, then a user operating the remote control at a location far from a right side of the TV may be positioned at an angle that may impede successful communication between the remote control and the TV. This is because the remote receiver may be inset from a surface of the TV and protected by a transparent cover. Signals arriving at the remote receiver at an acute angle are liable to be partially deflected by a surface of the transparent cover, and another portion of the arriving signals may miss the sensitive area of the remote receiver even after passing through the transparent cover.

### BRIEF DESCRIPTION OF THE DRAWINGS

The accompanying drawings are included to provide a further understanding of the disclosure. The drawings illustrate embodiments of the disclosure and, together with the description, serve to explain the principles of the disclosure.

FIG. 1 is a schematic front plan view of a flat panel television according to an exemplary embodiment of the present disclosure, the television having a remote control signal receiver.

FIG. 2 is a schematic, enlarged, cross-sectional view of part of FIG. 1, taken along a line II-II thereof.

FIG. 3 illustrates a working principal of the television of FIG. 1 when remotely controlled from an area to the right of the remote control signal receiver of the television.

FIG. 4 is similar to FIG. 3, but showing a working principal of the television when remotely controlled from an area to the left of the remote control signal receiver of the television.

### DETAILED DESCRIPTION

Reference will now be made to the drawings to describe certain exemplary embodiments of the present disclosure in detail.

In the present disclosure, a device with a remote receiver for receiving remote control signals emitted from a remote control is disclosed. The device includes a body and a supporting element for fixing and supporting the body. For example, if the device is a flat panel television, the body corresponds to a display module for displaying images. In another example, if the device is a DVD player, the body is an optical disk drive for receiving and playing DVD media. The remote receiver is embedded in a front surface of the body of the device. The front surface is defined as a main operation surface, and the remote receiver is disposed at one part of the main operation surface. In particular, the remote receiver is disposed at one side of the main operation surface relative to a vertical center axis of the main operation surface. A flat panel television is used as an example in the following description.

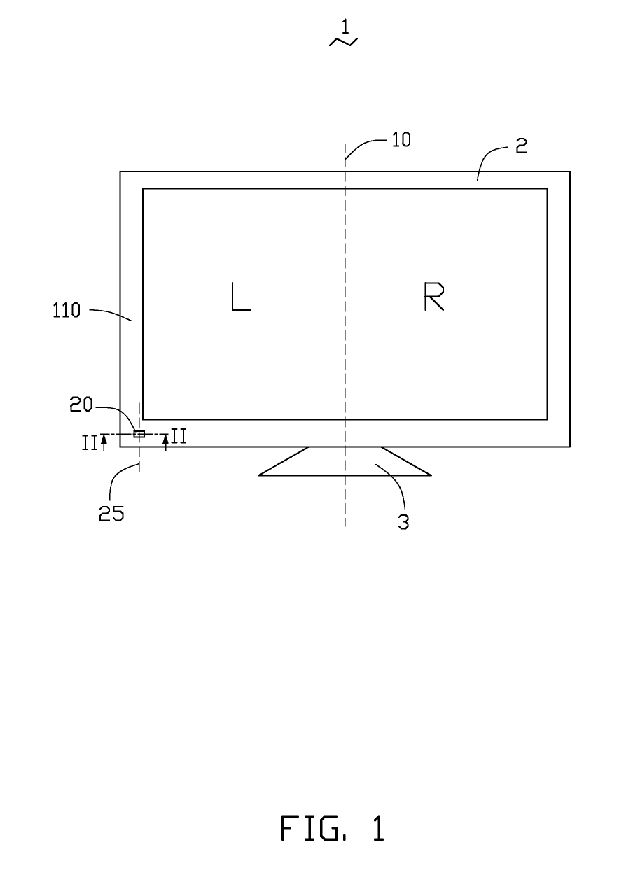

Referring to FIG. 1, a front plan view of the flat panel television according to an exemplary embodiment of the present disclosure is shown. The flat panel television 1 includes a display module 2 as a body, and a stand 3 as a supporting element. A front surface of the display module 2 facing towards users is the main operation surface 110. A vertical first center reference plane 10 of the display module 2 at the main operation surface 110 divides the display module 2 into a left side L and a right side R. In the embodiment, a remote receiver 20 is disposed at a left-bottom corner of the left side L.

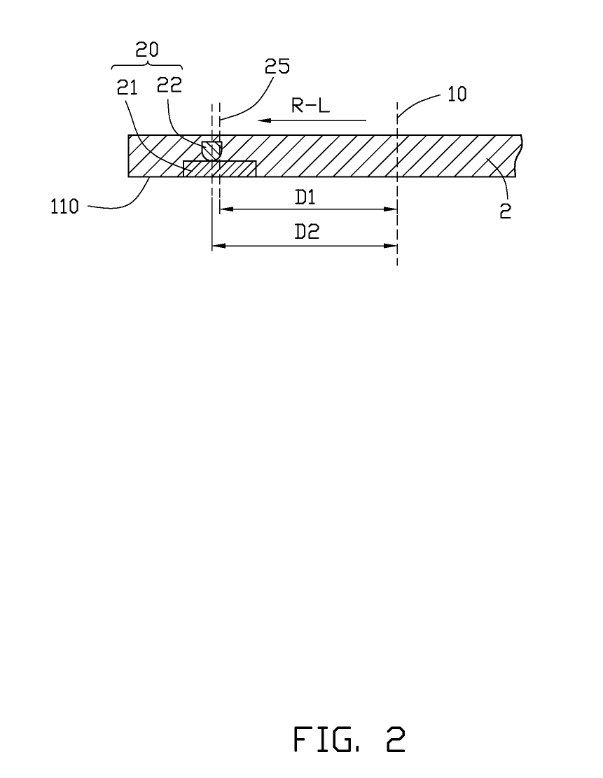

Referring also to FIG. 2, the remote receiver 20 includes a protection window 21, and a remote receiving head 22 behind the protection window 21. Remote control signals in the form of infrared (IR) ray signals can pass through the protection window 21 to the remote receiving head 22. The protection window 21 is provided to protect the remote receiving head 22 from being broken or soiled. Both the remote receiving head 22 and the protection window 21 are disposed in a receiving space defined in the main operation surface 110. A light incident surface of the protection window 21 is substantially coplanar with the main operation surface 110. The protection window 21 has a rectangular shape. A vertical second center reference plane 25 of the display module 2 at and including the remote receiver 20 divides the remote receiver 20 into two equal halves. The second center reference plane 25 is parallel to the first center reference plane 10 of the display module 2. The protection window 21 can be, for example, a transparent lens, a translucent plastic body, or another suitable object that allows the remote control signals to pass therethrough. In the present embodiment, the protection window 21 is a transparent rectangular lens. In FIG. 2, a direction from the first center reference plane 10 to the second center reference plane 25 of the remote receiver 20 is a reference direction R-L. A distance from the second center reference plane 25 to the first center reference plane 10 is defined as D1.

The center of the remote receiving head 22 is positioned to the left of the second center reference plane 25 (if the remote receiver 20 is located at the right side R of the flat panel television 1 then the position of the remote receiving head 22 is to the right side of the second center reference plane 25). This means a distance D2 from a center of the remote receiving head 22 to the first center reference plane 10 is greater than the distance D1. In this way, the remote receiving head 22 is in a position to receive IR signals coming from the extreme right of the flat panel television 1 as well as from the front and left of the flat panel television 1. Obviously the remote receiving head 22 cannot be positioned too far from the second center reference plane 25 or it would only receive IR signals from extreme angles.

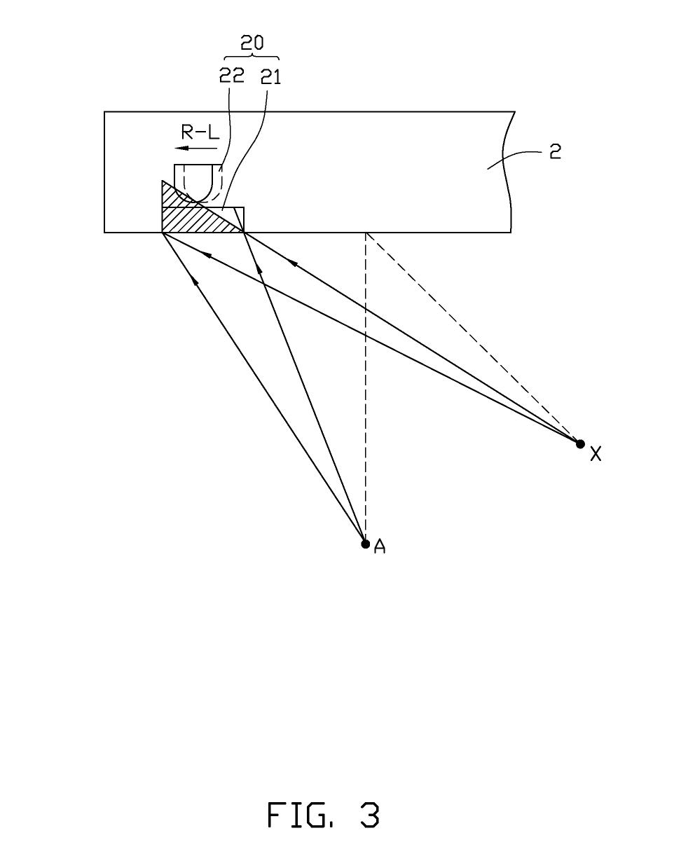

Referring to FIG. 3, this illustrates the difference between receiving angles of the remote receiving head 22 (indicated with a solid line) positioned according to the present disclosure compared to a typical placement of a conventional remote receiving head (indicated with a dashed line) aligned with the second center reference plane 25 of the protective cover 21. An emitting point A denotes an emitting source (remote control) located squarely in front of the display module 2 and emitting IR ray signals. The IR ray signals clearly strike the remote receiving head 22, and would also strike the conventional remote receiving head. An emitting point X denotes an emitting source (remote control) located farther to the right than the emitting point A. When a normal is drawn from the emitting point A to the display module 2, the emitting point A and the emitting point X define a first angle (not labeled) therebetween. A first distance (not shown) is defined between the emitting point X and the display module 2. It is clear that IR ray signals emitting from the emitting point X can strike the remote receiving head 22, but would not strike the conventional remote receiving head.

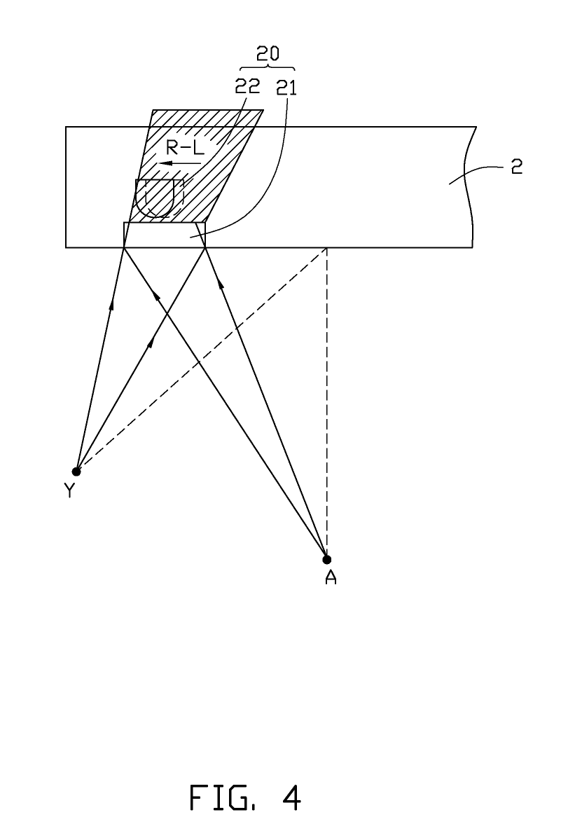

Referring to FIG. 4, the emitting point A and an emitting point Y are shown. The emitting point Y is located farther to the left than the emitting point A. When the normal is drawn from the emitting point A to the display module 2, the emitting point A and the emitting point Y define a second angle (not labeled) therebetween. The second angle is the same as the first angle. A second distance (not shown) is defined between the emitting point Y and the display module 2. The second distance is the same as the first distance. It is clear that even though the remote receiving head 22 is located to receive IR signals from the emitting point X, the remote receiving head 22 is still able to also receive IR signals from the emitting point Y.

Experimental results comparing the effectiveness of locating the remote receiving head 22 according to the present disclosure with the conventional remote receiving head placement are shown in Table 1. A remote control was operated from three different angles, namely±45° and 0° relative to the first center reference plane 10, to determine from how far away the remote control signals would be effective according to the two remote receiving head placement positions. In Table 1, the letter D denotes the angle in degrees, and the letter S denotes how far the remote receiving head 22 is shifted away from the second center reference plane 25 to the left. A 32-inch flat panel television was used, with a protection window 21 two centimeters wide and 0.5 centimeters thick. The remote receiver 20 was located at the bottom-left corner of the main operation surface 110 of the flat panel television.

TABLE 1

| D | | S = 0 | S = 1.5 mm |
|---|---|---|---|
| 0° | | 7.1 m | 7.1 m |
| 45° | (on the right side R) | 3.3 m | 4.5 m |
| −45° | (on the left side L) | 6.5 m | 5.7 m |

As can be seen in Table 1, when S is 1.5 mm, the remote control effective distance on the right side R increases by more than 36 percent, and the remote control effective distance on the left side is merely reduced by less than 13 percent. Therefore, the capability of the remote receiving head 22 of the present remote receiver 20 for sensing IR ray signals offers a greater effective range over conventionally placed remote receiving heads.

Other similar experimental results for ascertaining the effective ranges for S show that S should be in a critical range from more than 0 millimeters to 4 millimeters.

Moreover, in particular applications of the flat panel television 1, in practice most of the emitting points may be located on one side of the main operation surface 110 (i.e. either the left side L or the right side R). In such cases, the critical range for the shifting distance S of the remote receiving head 22 can be extended. For example, the critical range may be from more than 0 millimeters to, say, 5 millimeters. Such extended critical range can allow a maximum scope of remote control on said one side to be obtained, and such maximum scope is achieved by sacrificing (in part) the scope of remote control available on the other side.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size and arrangement of parts within the principles of the disclosure to the full extent indicated by the broad general meaning of the terms in which the appended claims are expressed.

What is claimed is:

1. A remote controllable display device, comprising:
a display module defining a vertical first center reference plane;
a remote receiver for receiving an external remote control signal, the remote receiver located at one side of the display device relative to the first center reference plane, the remote receiver comprising:
a protection window defining a vertical second center reference plane, a direction from the first center reference plane to the second center reference plane being a reference direction; and
a remote receiving head located behind the protection window to receive the external remote control signal via the protection window, wherein the remote receiving head is offset from the second center reference plane in a direction the same as the reference direction.

2. The remote controllable display device of claim 1, wherein when the remote receiver is located at one of a left side and a right side of the display module relative to the first center reference plane, the remote receiving head is correspondingly positioned to the same left or right side relative to the second center reference plane.

3. The remote controllable display device of claim 1, wherein the protection window is substantially rectangular, approximately 2 centimeters wide, and approximately 0.5 centimeters thick, and a distance that the remote receiving head is offset from the second center reference plane is in the range from more than 0 millimeters to approximately 4 millimeters.

4. The remote controllable display device of claim 1, wherein a distance that the remote receiving head is offset from the second center reference plane is about 1.5 millimeters.

5. The remote controllable display device of claim 1, wherein the protection window with the remote receiving head is embedded in a surface of the display module.

6. The remote controllable display device of claim 5, wherein the protection window comprises a light incident surface substantially coplanar with the surface of the display module.

7. A remote controllable display device, comprising:
a display module defining a vertical first center reference plane;
a remote receiver for receiving an external remote signal, the remote receiver located at one side of the display device relative to the first center reference plane, the remote receiver comprising:
a receiving window defining a vertical second center reference plane; and
a remote receiving head located behind the receiving window to receive the external remote signal via the receiving window, a first distance from a center of the remote receiving head to the first center reference plane being greater than a second distance from the second center reference plane to the first center reference plane.

8. The remote controllable display device of claim 7, wherein when the remote receiver is located at one side of the display module relative to the first center reference plane, the remote receiving head is positioned to a same side relative to the second center reference plane.

9. The remote controllable display device of claim 7, wherein when the protection window is substantially rectangular, approximately two centimeters wide and 0.5 centimeters thick, and a difference between the first distance and the second distance is more than 0 millimeter and less than approximately 4 millimeters.

10. The remote controllable display device of claim 8, wherein a difference between the first distance and the second distance is about 1.5 millimeters.

11. The remote controllable display device of claim 8, wherein the protection window with the remote receiving head is embedded in a surface of the display module.

12. The remote controllable display device of claim 11, wherein the protection window comprises a light incident surface substantially coplanar with the surface of the display module.

13. A remote controllable device, comprising:
a body including a main operation surface, the main operation surface defining a vertical first center reference plane;
a remote receiver for receiving an external remote control signal, the remote receiver located at one side of the main operation surface relative to the first center reference plane, thereby defining a reference direction from the first center reference plane to the location of the remote receiver, the remote receiver comprising:
a protection window defining a vertical second center reference plane, a direction from the first center reference plane to the second center reference plane being a reference direction; and
a remote receiving head located behind the protection window to receive the external remote control signal via the protection window, wherein the remote receiving head is offset from the second center reference plane in a direction the same as the reference direction.

14. The remote controllable device of claim 13, wherein when the remote receiver is located at one side of the device relative to the first center reference plane, the remote receiving head is positioned to a same side relative to the second center reference plane.

15. The remote controllable device of claim 13, wherein when the protection window is substantially rectangular, approximately two centimeters wide and 0.5 centimeters thick, and a difference between the first distance and the second distance is more than 0 millimeter and less than approximately 4 millimeters.

16. The remote controllable device of claim 13, wherein a distance from the position that the remote receiving head is offset from the second center reference plane is about 1.5 millimeters.

17. The remote controllable device of claim 13, wherein the protection window with the remote receiving head is embedded in a surface of the body.

18. The remote controllable device of claim 17, wherein the protection window comprises a light incident surface substantially coplanar with the surface of the body.

19. The remote controllable device of claim 13, wherein the first center reference plane and the second center reference plane parallel to each other.
